(19) United States
(12) Patent Application Publication
(10) Pub. No.: US 2015/0054347 A1
(43) Pub. Date: Feb. 26, 2015

(54) POWER TRANSMITTING APPARATUS, METHOD OF CONTROLLING THE SAME, AND NON-TRANSITORY COMPUTER-READABLE STORAGE MEDIUM

(71) Applicant: CANON KABUSHIKI KAISHA, Tokyo (JP)

(72) Inventor: Ryosuke Amano, Tokyo (JP)

(21) Appl. No.: 14/328,512

(22) Filed: Jul. 10, 2014

(30) Foreign Application Priority Data
Aug. 22, 2013 (JP) 2013-172660

(51) Int. Cl. H04B 5/00

(52) U.S. Cl. CPC H04B 5/0087; H04B 5/0037
USPC 307/104

(57) ABSTRACT

A power transmitting apparatus comprises a plurality of coils configured to wirelessly transmit power. The power transmitting apparatus receives information representing receiving performance from a power receiving apparatus, and, based on the information representing the receiving performance, assigns output values to a first coil and a second coil out of the plurality of coils such that the first coil and the second coil have different transmission power amounts.

### BACKGROUND OF THE INVENTION

1. Field of the Invention

The present invention relates to a power transmitting apparatus for wirelessly transmitting power, a method of controlling the same, and a non-transitory computer-readable storage medium.

2. Description of the Related Art

Methods of wirelessly transmitting power include an electromagnetic induction method, a magnetic resonance method, an electric field coupling method, and an electric wave receiving method. In the electromagnetic induction method and the magnetic resonance method, power is transmitted using coupling, via a space, between coils mounted on respective apparatuses. In the electric field coupling method, power is transmitted using coupling, via a space, between electrodes mounted on respective apparatuses. In the electric wave receiving method, electric waves are transmitted/received between antennas mounted on respective apparatuses, thereby transmitting power.

There is known an arrangement in which a coil is commonly used in wireless communication and wireless power transmission to impart a wireless communication function to a wireless power transmission system (Japanese Patent Laid-Open No. 2010-284065). Also known is a method of adjusting a transmission power amount in a wireless power transmission system. For example, an arrangement has been proposed, which calculates a transmission efficiency by receiving information about a reception power amount from a power receiving apparatus, and adjusts a transmission power amount so as to obtain a desired reception power amount on the power receiving apparatus side (Japanese Patent Laid-Open No. 2010-252497).

For a power transmitting apparatus in which a plurality of transmission coils are arranged, there is known a method that detects the position of a reception coil whereby wireless power transmission is performed using a transmission coil having a high transmission efficiency. For example, an arrangement has been proposed, which arranges an excitation coil and detects the position of a power receiving apparatus using a magnetic field (Japanese Patent Laid-Open No. 2008-283789).

WPC (Wireless Power Consortium) that is a standardization organization of wireless power transmission has developed the Qi standard (http://www.wirelesspowerconsortium.com/). The Qi standard defines an arrangement in which no excitation coil is used, and instead, a plurality of transmission coils are arranged so as to overlap, and one transmission coil having a high transmission efficiency is selected to feed power. When the method of the Qi standard is used, the degree of freedom in the position of the reception coil can be improved without providing special hardware for position detection such as an excitation coil.

In the power transmitting apparatus in which a plurality of transmission coils are arranged, wireless power transmission is preferably done by selecting a transmission coil having a high transmission efficiency in accordance with the position of the reception coil. However, when the plurality of transmission coils are arranged so as to overlap as in the arrangement standardized by WPC, inductive currents are generated in the transmission coils arranged in the periphery of the transmission coil used to execute power transmission, and the transmission efficiency lowers. On the other hand, when the transmission coils are arranged at a certain distance, inductive currents of the peripheral transmission coils can be suppressed. In this case, however, since the position of the reception coil and that of the transmission coil do not match, the transmission efficiency lowers, and no sufficient reception power amount can be obtained on the power receiving apparatus side. It is therefore possible to feed a reception power amount desired by the power receiving apparatus while suppressing generated inductive currents.

### SUMMARY OF THE INVENTION

The present invention has been made in consideration of the above-described problems, and enables power transmission to a power receiving apparatus at a high transmission efficiency.

According to one aspect of the present invention, there is provided a power transmitting apparatus comprising: a plurality of coils configured to wirelessly transmit power; a reception unit configured to receive information representing receiving performance from a power receiving apparatus; and a control unit configured to, based on the information representing the receiving performance, assign output values to a first coil and a second coil out of the plurality of coils such that the first coil and the second coil have different transmission power amounts.

Further features of the present invention will become apparent from the following description of exemplary embodiments (with reference to the attached drawings).

### BRIEF DESCRIPTION OF THE DRAWINGS

FIG. 1 is a view schematically showing the system arrangement of a wireless power transmission system;

FIG. 2 is a block diagram showing the arrangement of the power transmitting apparatus;

FIG. 3 is a view showing an example of the arrangement of transmission coils provided in a power transmitting apparatus;

FIG. 4 is a flowchart showing the processing procedure of wireless power transmission processing;

FIG. 5 is a flowchart showing the processing procedure of trial power transmission processing;

FIG. 6 is a flowchart showing the processing procedure of transmission power amount calculation processing;

FIG. 7 is a view showing an example of a power receiving apparatus that displays a message;

FIG. 8 is a view showing examples of power receiving apparatuses that display messages; and

FIG. 9 is a flowchart showing the processing procedure of trial power transmission processing.

### DESCRIPTION OF THE EMBODIMENTS

The embodiments of the present invention will now be described in detail with reference to the accompanying drawings.

### First Embodiment

### System Arrangement

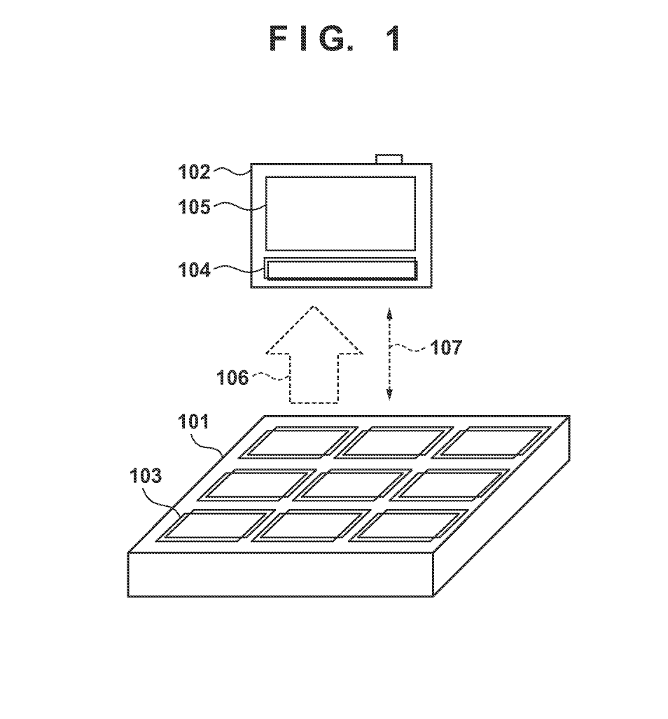

FIG. 1 is a view showing the system arrangement of a wireless power transmission system according to this embodiment. A power transmitting apparatus 101 wirelessly transmits power. A power receiving apparatus 102 receives the power transmitted by the power transmitting apparatus 101. A transmission coil 103 is used for power transmission of the power transmitting apparatus 101. A reception coil 104 is used for power reception of the power receiving apparatus 102. Note that in this embodiment, two or more transmission coils 103 are arranged in the power transmitting apparatus 101. The power receiving apparatus 102 includes a display unit 105.

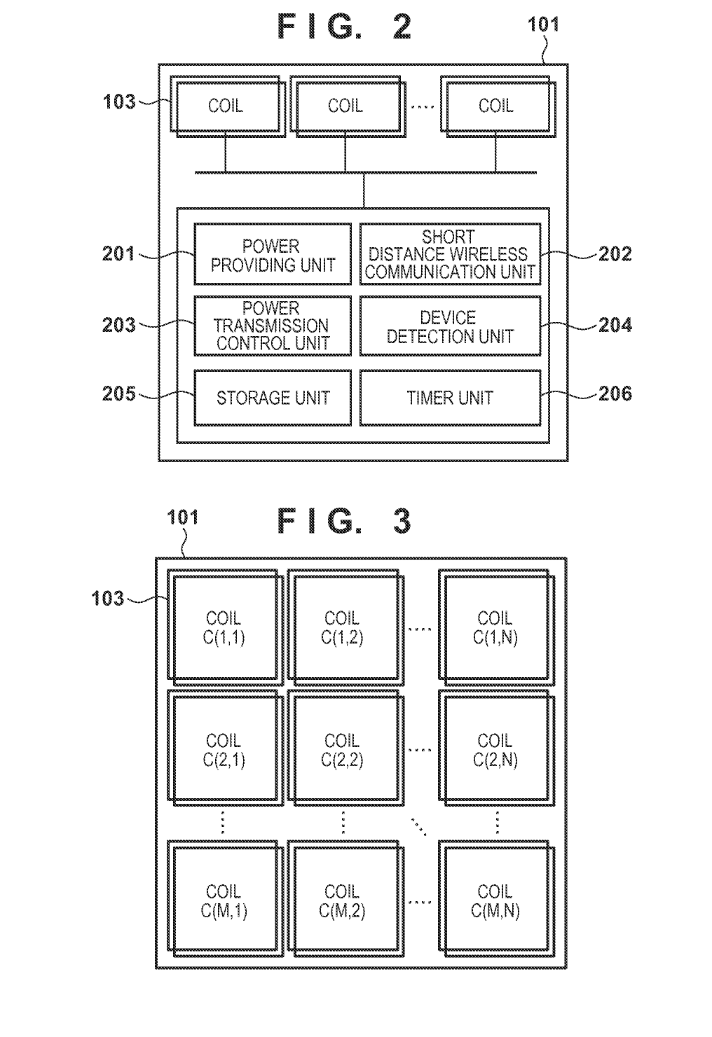

FIG. 2 is a view showing an example of the arrangement of the transmission coils provided in the power transmitting apparatus. In this embodiment, an arrangement in which M×N transmission coils 103 are arranged in an array of M rows×N columns, as shown in FIG. 2, will be explained. M and N are natural numbers of 1 or more. Note that the transmission coils 103 may be arranged in a form other than an array. In this embodiment, the transmission coil 103 of the sth row and tth column will be expressed as C[s, t].

When the power receiving apparatus 102 is brought close to the power transmitting apparatus 101, the power transmitting apparatus 101 can feed power to the power receiving apparatus 102 by wireless power transmission 106. The wireless power transmission 106 uses an electromagnetic induction method, a magnetic resonance method, an electric field coupling method, an electric wave receiving method, or the like. The wireless power transmission system according to this embodiment uses the magnetic resonance method of performing wireless power transmission and wireless communication via coils. Note that the arrangement according to this embodiment is applicable not only within the range of the magnetic resonance method but also to a wireless power transmission system of another method.

When the power transmitting apparatus 101 and the power receiving apparatus 102 are brought close to each other, they can perform data communication via short distance wireless communication 107. As the short distance wireless communication 107, noncontact IC card wireless communication or NFC (Near Field Communication) using electromagnetic induction, communication using an inductive electric field, or the like is usable. In all the communication methods, the communication speed is several hundred kbps at maximum, the communication enable range falls within several cm, and the network configuration is one-to-one communication between apparatuses. The power transmitting apparatus 101 according to this embodiment uses a coil shared for the wireless power transmission 106 and the short distance wireless communication 107. However, separate coils may be provided.

(Arrangement of Power Transmitting Apparatus)

FIG. 3 is a block diagram showing the arrangement of the power transmitting apparatus 101. Components shown in FIG. 3 are implemented by causing the CPU (Central Processing Unit) of the power transmitting apparatus 101 to execute computer programs. However, all or some of the constituent elements may be formed by dedicated hardware.

A power providing unit 201 controls the transmission coils 103. The power providing unit 201 can provide power for power transmission to the transmission coils 103.

A short distance wireless communication unit 202 performs the short distance wireless communication 107. The short distance wireless communication unit 202 transmits a connection request via the transmission coils 103 and, upon receiving a response from the power receiving apparatus 102, establishes the short distance wireless communication 107. Note that the short distance wireless communication unit 202 may establish the short distance wireless communication 107 by receiving a connection request from the power receiving apparatus 102 and returning a response.

A power transmission control unit 203 controls the power providing unit 201 and decides the transmission power amount of each transmission coil 103. The power transmission control unit 203 tries power transmission from each transmission coil 103 to the power receiving apparatus 102, receives feedback information about the reception power amount, and decides the transmission power amount from each transmission coil 103 from then on. Feedback information is information representing receiving performance from a coil. In this embodiment, feedback information represents the value of a reception power amount per unit time actually measured on the side of the power receiving apparatus 102 for power transmission from each transmission coil 103. Note that the feedback information may represent the value of a total reception power amount or transmission efficiency measured on the side of the power receiving apparatus 102. Processing of deciding the transmission power amount of each transmission coil 103 will be described later.

A device detection unit 204 detects the power receiving apparatus 102 using the short distance wireless communication 107. The device detection unit 204 switches the transmission coil 103 and transmits or receives a connection request by controlling the short distance wireless communication unit 202, thereby establishing the short distance wireless communication 107. More specifically, the device detection unit 204 sequentially switches the transmission coils 103, tries communication from each coil to the power receiving apparatus 102, and detects the existence of the power receiving apparatus 102 in accordance with possibility/impossibility of the communication. Note that since the device detection unit 204 can detect one power receiving apparatus in correspondence with one transmission coil, a plurality of power receiving apparatuses may be detected using a plurality of transmission coils. In this case, however, the device detection unit 204 needs to obtain the identification information of each power receiving apparatus and determine that a power receiving apparatus is a different individual (apparatus).

A storage unit 205 stores various kinds of information. A timer unit 206 counts time.

(Wireless Power Transmission Processing)

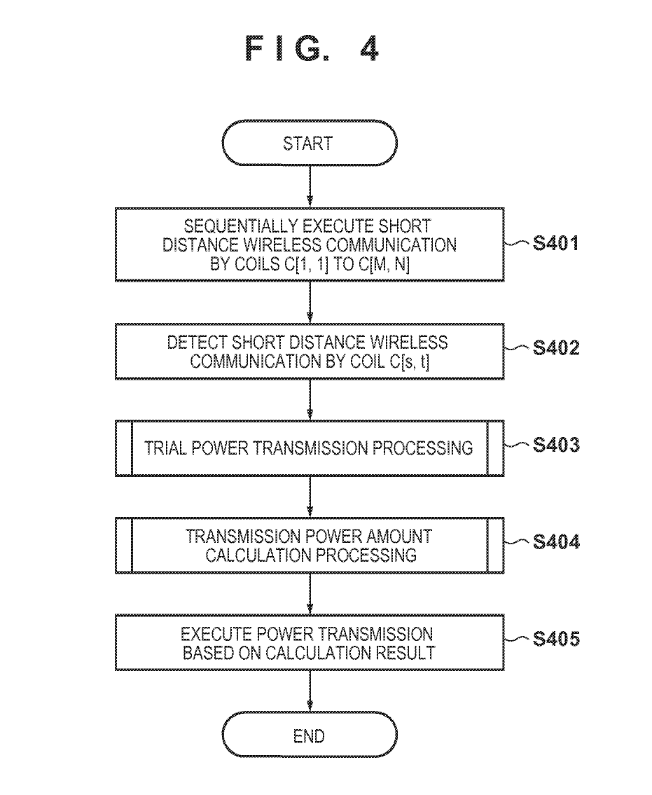

The operation of the wireless power transmission system according to this embodiment will be described below with reference to the flowcharts of FIGS. 4, 5, and 6. A description will be made by focusing control of the power transmitting apparatus 101. Steps to be described below are executed under the control of the CPU (not shown) of the power transmitting apparatus 101. In the initial state, neither the wireless power transmission 106 nor the short distance wireless communication 107 has started.

FIG. 4 is a flowchart showing the processing procedure of wireless power transmission processing. The device detection unit 204 sequentially switches the transmission coils 103, and tries establishment of the short distance wireless communication 107 (step S401). More specifically, for i=1, 2, . . . , M, and j=1, 2, . . . , N, the device detection unit 204 sequentially performs connection request transmission/reception from the transmission coil C[i, j], thereby searching for the transmission coil 103 capable of performing the short distance wireless communication 107. In this embodiment, a description will be made below assuming that the device detection unit 204 has established the short distance wireless communication 107 with the power receiving apparatus 102 in the transmission coil C[s, t]. Note that upon detecting a plurality of power receiving apparatuses, the device detection unit 204 performs subsequent processing for the transmission coils 103 that have established the short distance wireless communication 107 with the respective power receiving apparatuses. In this embodiment, when one of the transmission coils 103 has established the short distance wireless communication 107 in course of sequential trial of the device detection unit 204 for establishment of the short distance wireless communication 107, the device detection unit 204 sets the transmission coil 103 as the transmission coil C[s, t], and ends the process of step S401 at that point of time. However, all transmission coils 103 may try establishment of the short distance wireless communication 107. In this case, when a plurality of transmission coils 103 have established the short distance wireless communication 107, the device detection unit 204 can set, as C[s, t], the transmission coil 103 located at the center out of the transmission coils 103 that have established the short distance wireless communication 107.

When short distance wireless communication unit 202 detects that the power receiving apparatus 102 exists within the communicable zone of the short distance wireless communication 107 (step S402), the power transmission control unit 203 executes trial power transmission processing (step S403). Trial power transmission processing is processing of causing the power transmission control unit 203 to perform tentative power transmission from each transmission coil 103 existing in the neighborhood of the transmission coil C[s, t] that has established the short distance wireless communication 107 and obtain feedback information from the power receiving apparatus 102. The detailed processing procedure of the trial power transmission processing will be described later.

When the trial power transmission processing (step S403) ends, the power transmission control unit 203 executes transmission power amount calculation processing (step S404). Transmission power amount calculation processing is processing of causing the power transmission control unit 203 to calculate the transmission power amount to be transmitted from each transmission coil 103 based on the transmission efficiency of the transmission coil 103 calculated from the feedback information. In the transmission power amount calculation processing, the power transmission control unit 203 assigns a transmission power amount to each of the transmission coils 103 existing in the neighborhood of the transmission coil C[s, t] sequentially in descending order of transmission efficiency as a coil that should perform power transmission. The detailed processing procedure of the transmission power amount calculation processing will be described later.

When the transmission power amount calculation processing (step S404) ends, the power providing unit 201 provides power in accordance with the calculated transmission power amount of each transmission coil 103 (step S405). Power providing is performed by causing all transmission coils 103 that should perform power transmission to transmit power simultaneously. However, to prevent the transmission efficiency from lowering due to generation of inductive currents caused by power transmission between the neighboring transmission coils 103, power transmission may be performed by sequentially switching the transmission coil 103 to do power transmission. When power providing is completed, the power providing unit 201 ends the process of step S405.

Note that when the short distance wireless communication unit 202 detects movement or disassociation of the power receiving apparatus 102 or addition of another power receiving apparatus, the process may return to step S401 or S402 to perform tentative power transmission from each transmission coil 103 again. The short distance wireless communication unit 202 can detect movement or disassociation of the power receiving apparatus 102 or addition of a new apparatus by, for example, detecting a change in the impedance value of the transmission coil 103 or causing the device detection unit 204 to periodically perform power receiving apparatus detection processing.

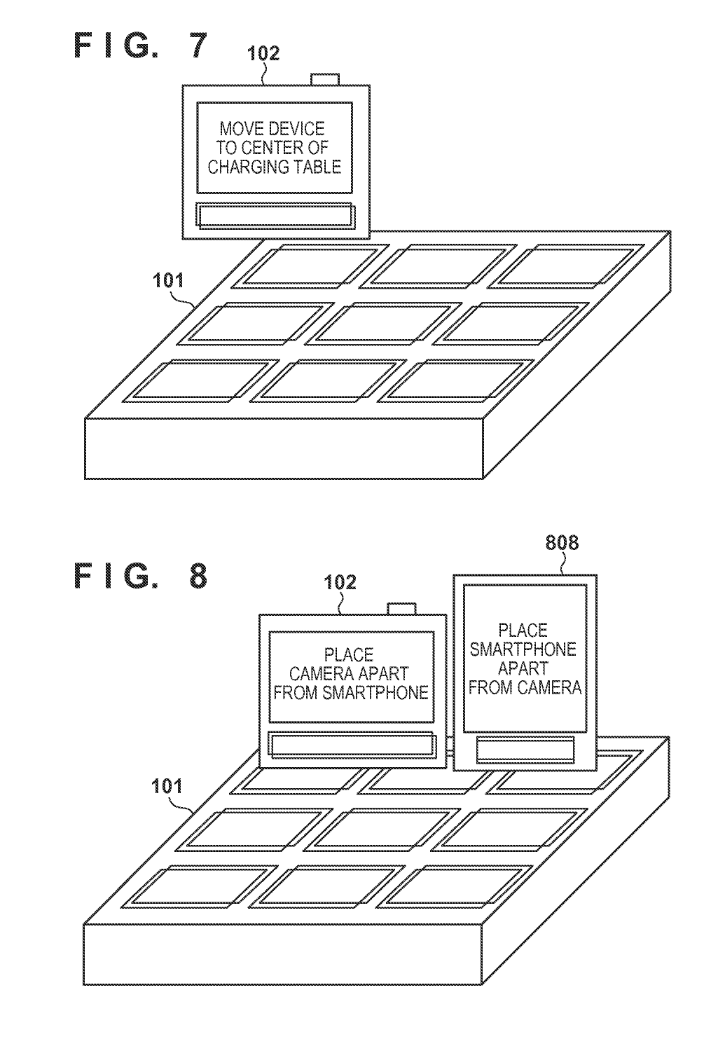

If the transmission power amount calculated by the power transmission control unit 203 does not meet W_target in the transmission power amount calculation processing (step S404), the power receiving apparatus 102 may display a message as shown in FIG. 7 or 8 on the display unit 105 to prompt the user to move the power receiving apparatus 102. FIGS. 7 and 8 are views showing examples of the power receiving apparatus that displays a message. At this time, the power transmitting apparatus 101 may notify, via the short distance wireless communication 107, the power receiving apparatus 102 of a message display request or information necessary to display a message. For example, FIG. 8 shows an example in which when the power transmitting apparatus 101 cannot provide sufficient power to the power receiving apparatus 102 (camera) and a power receiving apparatus 808 (smartphone), messages that prompt the user to arrange the power receiving apparatuses apart from each other are displayed. As described above, upon determining that sufficient power cannot be transmitted to the power receiving apparatus 102, the power transmitting apparatus 101 sends information to instruct display of a message for prompting movement to the power receiving apparatus 102 and causes it to display the message. The user can thus move the power receiving apparatus 102 to a more appropriate position.

(Trial Power Transmission Processing)

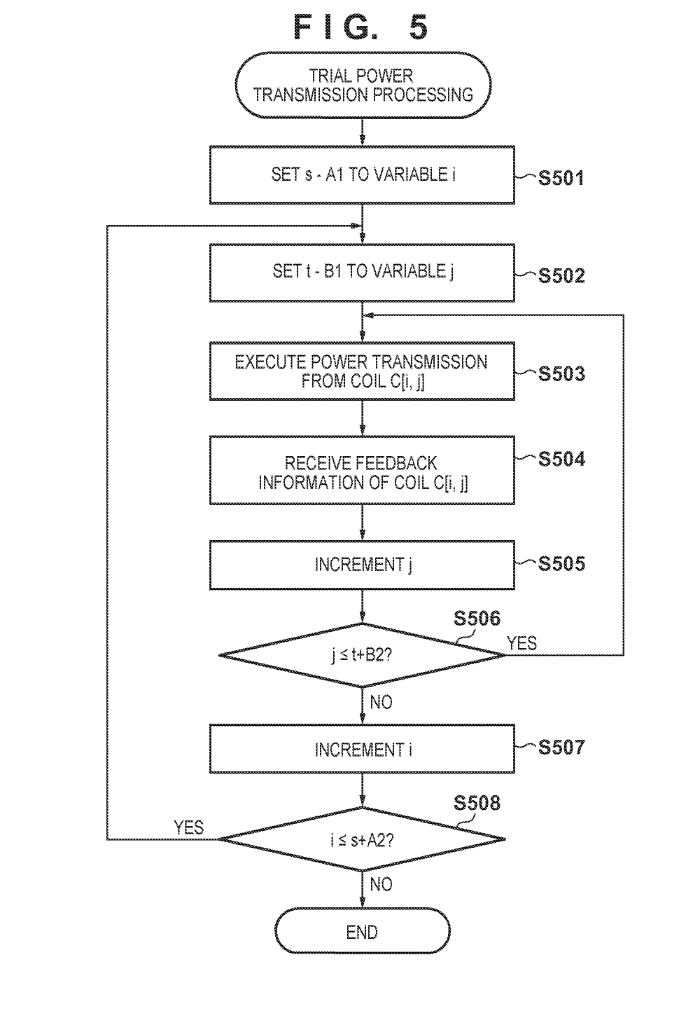

The detailed processing procedure of trial power transmission processing executed in step S403 of FIG. 4 will be described next with reference to FIG. 5. FIG. 5 is a flowchart showing the processing procedure of trial power transmission processing. In trial power transmission processing, the power transmission control unit 203 sequentially tries power transmission from the transmission coils 103 in the neighborhood of the transmission coil C[s, t] whose establishment of the short distance wireless communication 107 has been detected, and obtains feedback information from the power receiving apparatus 102 via the short distance wireless communication 107. In this case, the power transmission control unit 203 sets the range of neighboring transmission coils as a range from the (s−A1)th row to the (s+A2)th row and from the (t−B1)th column to the (t+B2)th column. A1 and A2 are integers of 0 (inclusive) to M (inclusive), and B1 and B2 are integers of 0 (inclusive) to N (inclusive).

First, the power transmission control unit 203 sets a variable i to (s−A1) (step S501), sets a variable j to (t−B1) (step S502), and tries power transmission from the transmission coil C[i, j] (step S503). After the elapse of a predetermined time, the power transmission control unit 203 stops power transmission, and obtains and stores feedback information concerning the transmission coil C[i, j] (step S504). The power transmission control unit 203 increments the value of the variable j by one (step S505), and determines whether the value of the variable j is equal to or smaller than (t+B2) (step S506). If the value of the variable j is equal to or smaller than (t+B2) (YES in step S506), the power transmission control unit 203 returns to the process of step S503.

If the value of the variable j is larger than (t+B2) (NO in step S506), the power transmission control unit 203 increments the value of the variable i by one (step S507), and determines whether the value of the variable i is equal to or smaller than (s+A2) (step S508). If the value of the variable i is equal to or smaller than (s+A2) (YES in step S508), the power transmission control unit 203 returns to the process of step S502. If the value of the variable i is larger than (s+A2) (NO in step S508), the power transmission control unit 203 ends the trial power transmission processing (step S403).

In this way, the power transmission control unit 203 performs tentative power transmission from each transmission coil C[i, j] for i=s−A1, . . . , s+A2, and j=t−B1, . . . , t+B2, and obtains feedback information for each power transmission. Note that in this embodiment, the power transmitting apparatus 101 obtains feedback information from the single power receiving apparatus 102. However, when a plurality of power receiving apparatuses exist, feedback information may individually be obtained from each power receiving apparatus. In this embodiment, the power transmission control unit 203 tries power transmission sequentially from the transmission coil 103 with smaller row and column numbers. However, power transmission may be executed in another order.

(Transmission Power Amount Calculation Processing)

In transmission power amount calculation processing executed in step S404 of FIG. 4, the transmission power amount of each transmission coil 103 is calculated in accordance with an algorithm to be described below. Note that the algorithm to be described below is merely an example, and the transmission power amount may be calculated using another algorithm.

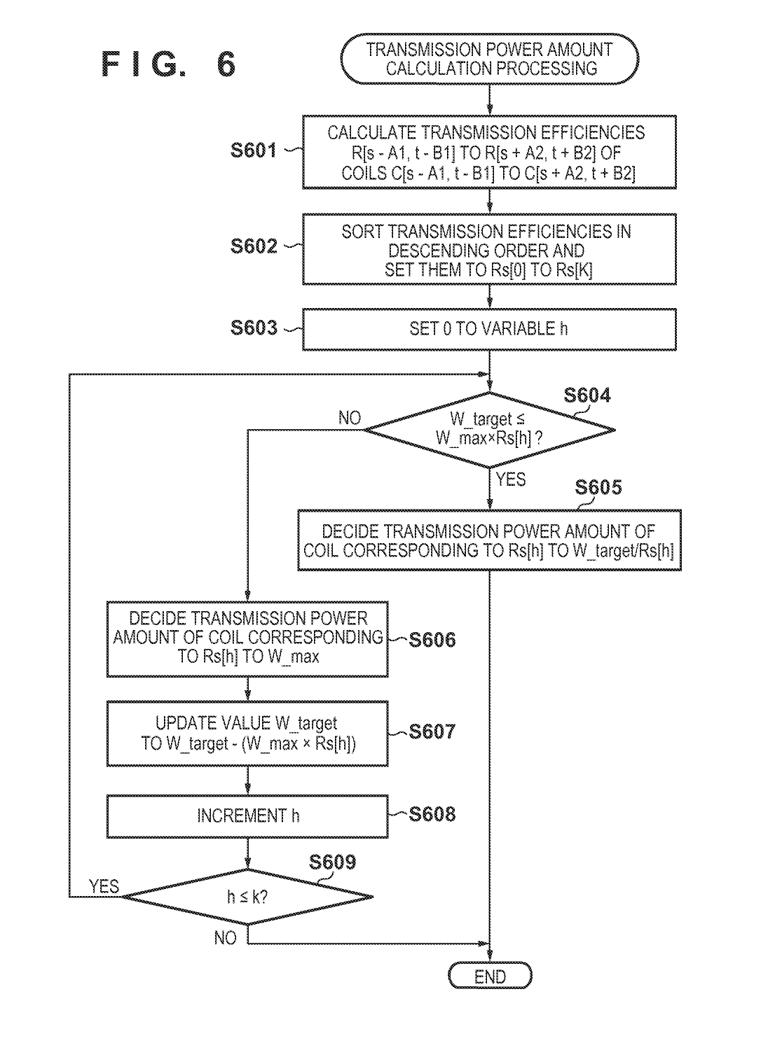

FIG. 6 is a flowchart showing the processing procedure of transmission power amount calculation processing. Referring to FIG. 6, first, the power transmission control unit 203 calculates the transmission efficiency of each stored transmission coil 103 (step S601). The power transmission control unit 203 decides a value obtained by dividing a reception power amount represented by feedback information concerning the transmission coil C[s, t] by the transmission power amount per unit time as a transmission efficiency R[s, t]. In addition, the power transmission control unit 203 rearranges the transmission efficiencies of the transmission coils 103 in descending order, and sets them to Rs[0] to Rs[K−1] (step S602). The value K matches the number of transmission coils 103 that have tried power transmission in trial power transmission processing (step S403). In this embodiment, since the transmission coils 103 are arranged in an array, the value K is {(A1+A2)×(B1+B2)}.

Note that in the above description, the power transmission control unit 203 sets the transmission efficiencies of all transmission coils that have tried power transmission to Rs[0] to Rs[K−1]. However, for the transmission coil 103 whose transmission efficiency is lower than a threshold, the transmission efficiency need not be set to Rs. Hence, in this case, the value K matches a value obtained by subtracting the number of transmission coils having transmission efficiencies lower than the threshold from {(A1+A2)×(B1+B2)}.

A description will be made below assuming that the maximum transmission power amount per unit time of each transmission coil is W_max, and the reception power amount per unit time as the target of the power receiving apparatus 102 is W_target. The power transmission control unit 203 sets a variable h to 0 (step S603), and compares the value (W_max×Rs[h]) and the value W_target (step S604). Note that in this embodiment, a description will be made assuming that W_target is a value determined by the power transmitting apparatus 101. However, the power transmitting apparatus 101 may obtain the value W_target from the power receiving apparatus 102 via the short distance wireless communication 107.

If (W_max×Rs[h]) is equal to or larger than W_target (YES in step S604), the power transmission control unit 203 decides the transmission power amount of the transmission coil 103 corresponding to Rs[h] to (W_target/Rs[h]) (step S605), and ends the transmission power amount calculation processing (step S404).

If (W_max×Rs[h]) is smaller than W_target (NO in step S604), the power transmission control unit 203 decides the transmission power amount of the transmission coil 103 corresponding to Rs[h] to W_max (step S606). Then, the power transmission control unit 203 updates the value W_target to {W_target−(W_max×Rs[h])} (step S607).

The power transmission control unit 203 increments the value of the variable h by one (step S608), and compares the variable h and the value k (step S609). If the value of the variable h is equal to or smaller than the value K (YES in step S609), the power transmission control unit 203 returns to the process of step S604. If the value of the variable h is larger than the value K (NO in step S609), the power transmission control unit 203 ends the transmission power amount calculation processing.

Note that the power transmission control unit 203 decides the transmission power amount to 0 for a transmission coil whose transmission power amount is not decided by the above-described transmission power amount calculation processing. When a plurality of power receiving apparatuses are detected, the power transmission control unit 203 needs to set the value of the maximum transmission power amount W_max of the transmission coil 103 so as not to cause an overcurrent, overvoltage, and overcharging in any of the power receiving apparatuses.

As described above, according to this embodiment, when the plurality of transmission coils 103 are arranged in the power transmitting apparatus 101, the power transmitting apparatus 101 can perform wireless power transmission of an optimum transmission power amount from each transmission coil 103 by obtaining the transmission efficiency of each transmission coil 103. The optimum transmission power amount means providing a target reception power amount to the power receiving apparatus 102 without applying an excessive current/voltage to each transmission coil 103. In this embodiment, the power transmitting apparatus 101 prohibits a coil having a transmission efficiency lower than a predetermined threshold from transmitting power. Since a transmission power amount is assigned to each coil sequentially in descending order of transmission efficiency as a coil that should transmit power, the coils can efficiently be used. According to this embodiment, such a characteristic feature makes it possible to transmit power to the power receiving apparatus placed at a free position within a predetermined range at a high transmission efficiency without requiring special hardware.

The power transmitting apparatus 101 detects the position of the power receiving apparatus 102 by the short distance wireless communication 107. Hence, it is unnecessary to arrange special hardware for position detection, and the cost and space necessary for arranging hardware can be suppressed. In this embodiment, since the power transmitting apparatus 101 causes only coils existing within a predetermined range from a coil that has performed short distance wireless communication with the power receiving apparatus to do tentative power transmission, trial power transmission processing can efficiently be performed.

Even when the plurality of power receiving apparatuses 102 are detected, the power transmitting apparatus 101 can calculate the transmission efficiency of each transmission coil for each power receiving apparatus, and decide the optimum transmission power amount. When the power receiving apparatus 102 is placed at a position where no sufficient reception power amount is obtained, the power transmitting apparatus 101 displays a message so as to prompt the user to move the power receiving apparatus to an appropriate position, and causes the user to move the power receiving apparatus 102, thereby providing a sufficient reception power amount to the power receiving apparatus 102. The power transmitting apparatus 101 can also suppress generation of an inductive current by arranging the plurality of coils such that they do not overlap each other.

### Second Embodiment

In the first embodiment, the power transmitting apparatus 101 sequentially performs feedback information transmission/reception in trial power transmission processing every time the transmission coil 103 performs tentative power transmission. In the second embodiment, a power transmitting apparatus 101 performs feedback information transmission/reception at once after all transmission coils 103 that should perform trial power transmission processing have transmitted power, thereby speeding up trial power transmission processing. Many of the system arrangement and processing contents of a wireless power transmission system according to this embodiment are the same as in the first embodiment, and differences from the first embodiment will mainly be explained below.

The system arrangement of the wireless power transmission system and the arrangement of the power transmitting apparatus 101 according to this embodiment are illustrated in FIGS. 1 and 3. These arrangements are the same as in the first embodiment, and a description thereof will be omitted. The wireless power transmission system according to this embodiment executes processing in accordance with the flowcharts of FIGS. 4, 6, and 9. The processing procedures of wireless power transmission processing (FIG. 4) and transmission power amount calculation processing (FIG. 6) according to this embodiment are the same as in the first embodiment, and a description thereof will be omitted.

Details of trial power transmission processing executed in step S403 of FIG. 4 will be described below. A detailed description of the same parts as in the first embodiment will be omitted.

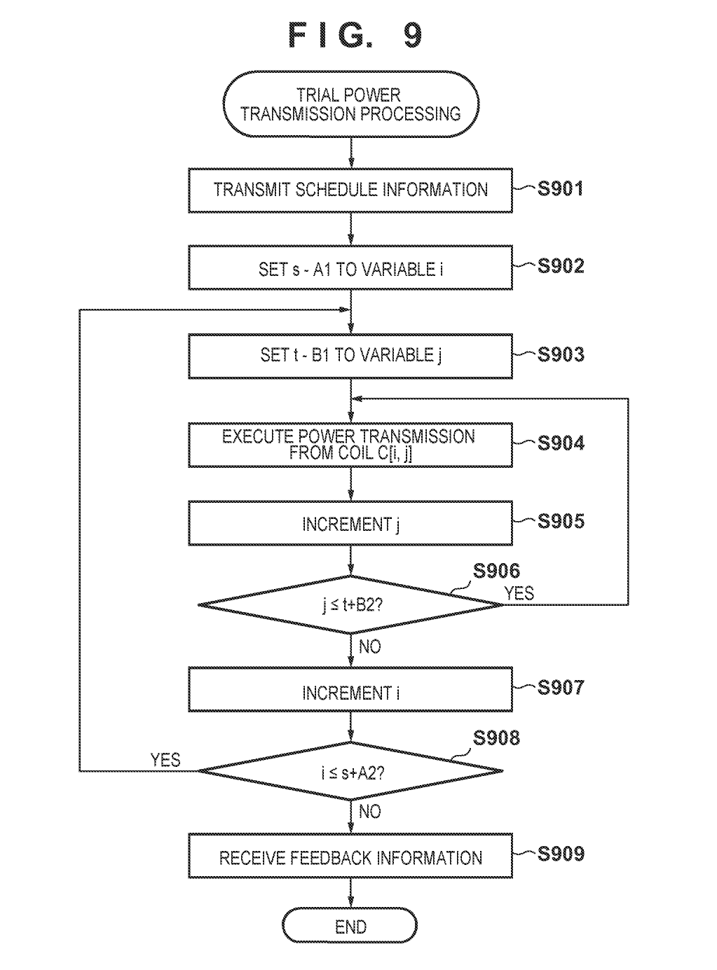

FIG. 9 is a flowchart showing the processing procedure of trial power transmission processing. First, a power transmission control unit 203 notifies, via short distance wireless communication 107, a power receiving apparatus 102 of schedule information that describes a schedule of trial power transmission (step S901). The schedule information includes at least the trial power transmission period (power-transmitting period) of each transmission coil. Note that the schedule information may include information of the number of transmission coils 103, the identifiers of the transmission coils 103, and the power transmission trial count or transmission power amount.

The power transmission control unit 203 sets a variable i to (s−A1) (step S902), sets a variable j to (t−B1) (step S903), and tries power transmission from a transmission coil C[i, j] (step S904). At this time, the power transmission control unit 203 executes trial power transmission from the transmission coil C[i, j] in accordance with the notified schedule information.

After the elapse of the trial power transmission period of the transmission coil C[i, j], the power transmission control unit 203 stops power transmission, increments the value of the variable j by one (step S905), and determines whether the value of the variable j is equal to or smaller than (t+B2) (step S906). If the value of the variable j is equal to or smaller than (t+B2) (YES in step S906), the power transmission control unit 203 returns to the process of step S904.

If the value of the variable j is larger than (t+B2) (NO in step S906), the power transmission control unit 203 increments the value of the variable i by one (step S907), and determines whether the value of the variable i is equal to or smaller than (s+A2) (step S908). If the value of the variable i is equal to or smaller than (s+A2) (YES in step S908), the power transmission control unit 203 returns to the process of step S903.

If the value of the variable i is larger than (s+A2) (NO in step S908), the power transmission control unit 203 obtains and stores feedback information concerning each transmission coil that has tried power transmission (step S909), and ends the trial power transmission processing (step S403). At this time, the feedback information obtained from the power receiving apparatus 102 needs to be described in a format that enables association with each transmission coil on the side of the power transmitting apparatus 101. For example, the feedback information is described in a format that associates the reception power amount with the order of trying power transmission or a format that associates the reception power amount with the identification information of the transmission coil 103.

As described above, according to this embodiment, the power transmitting apparatus 101 obtains the feedback information of the transmission coils 103 at once in trial power transmission processing (step S403), thereby speeding up trial power transmission processing (step S403).

As described above, according to the present invention, the power transmitting apparatus can feed a reception power amount desired by the power receiving apparatus while suppressing generation of inductive currents of transmission coils arranged in the periphery of a transmission coil that executes power transmission.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-172660, filed Aug. 22, 2013 which is hereby incorporated by reference herein in its entirety.

What is claimed is:

1. A power transmitting apparatus comprising:
a plurality of coils configured to wirelessly transmit power;
a reception unit configured to receive information representing receiving performance from a power receiving apparatus; and
a control unit configured to, based on the information representing the receiving performance, assign output values to a first coil and a second coil out of said plurality of coils such that the first coil and the second coil have different transmission power amounts.

2. The apparatus according to claim 1, wherein said control unit sequentially switches said plurality of coils and causes each coil to perform tentative power transmission,
said reception unit receives, from the power receiving apparatus, the information representing the receiving performance in response to the power transmission from each coil, and
said control unit decides the transmission power amount to be transmitted from each coil based on the information representing the receiving performance.

3. The apparatus according to claim 1, further comprising a detection unit configured to detect existence of the power receiving apparatus,
wherein upon detecting the existence of the power receiving apparatus, said control unit controls transmission of the power by said plurality of coils.

4. The apparatus according to claim 3, wherein said detection unit sequentially switches said plurality of coils, tries communication from each coil to the power receiving apparatus, and detects the existence of the power receiving apparatus in accordance with possibility/impossibility of the communication.

5. The apparatus according to claim 4, wherein said control unit causes each coil existing within a predetermined range from a coil that has performed the communication with the power receiving apparatus by said detection unit to perform power transmission to obtain the information representing the receiving performance.

6. The apparatus according to claim 3, wherein when said detection unit detects the existence of a plurality of power receiving apparatuses, said control unit causes each coil to perform power transmission to obtain the information representing the receiving performance for each of the plurality of power receiving apparatuses.

7. The apparatus according to claim 1, wherein said control unit calculates a transmission efficiency of each coil based on the information representing the receiving performance, and assigns the transmission power amount to each coil sequentially in descending order of transmission efficiency as a coil that should transmit the power.

8. The apparatus according to claim 7, wherein said control unit prohibits a coil having the transmission efficiency lower than a predetermined threshold from transmitting the power.

9. The apparatus according to claim 1, wherein said reception unit receives the information from the power receiving apparatus via a coil included in said plurality of coils.

10. The apparatus according to claim 1, wherein said control unit causes each coil to perform power transmission to obtain the information representing the receiving performance again upon detecting one of movement and disassociation of the power receiving apparatus.

11. The apparatus according to claim 1, wherein said control unit sends schedule information representing a schedule to cause each coil to perform power transmission to obtain the information representing the receiving performance to the power receiving apparatus via a coil included in said plurality of coils.

12. The apparatus according to claim 11, wherein the schedule information includes the number of said plurality of coils and a power-transmitting period of each coil.

13. The apparatus according to claim 1, wherein upon determining based on the receiving performance of each coil that sufficient power cannot be transmitted to the power receiving apparatus, said control unit sends information to instruct display of a message for prompting movement to the power receiving apparatus via a coil included in said plurality of coils.

14. The apparatus according to claim 1, wherein said plurality of coils are arranged in an array.

15. A method of controlling a power transmitting apparatus including a plurality of coils configured to wirelessly transmit power, the method comprising:
receiving information representing receiving performance from a power receiving apparatus; and
based on the information representing the receiving performance, assigning output values to a first coil and a second coil out of the plurality of coils such that the first coil and the second coil have different transmission power amounts.

16. A non-transitory computer-readable storage medium storing a computer program for controlling a computer to execute respective steps of claim 15.
